(19) United States
(12) Patent Application Publication
(10) Pub. No.: US 2014/0239745 A1
(43) Pub. Date: Aug. 28, 2014

(54) ROTARY TO LINEAR CONVERTER FOR DOWNHOLE APPLICATIONS

(71) Applicant: Oscilla Power Inc., Salt Lake City, UT (US)

(72) Inventors: Balakrishnan Nair, Sandy, UT (US); Andrew Joseph Gill, Salt Lake City, UT (US); James H. Dudley, Spring, TX (US)

(73) Assignee: Oscilla Power Inc., Salt Lake City, UT (US)

(21) Appl. No.: 14/191,381

(22) Filed: Feb. 26, 2014

Related U.S. Application Data
(60) Provisional application No. 61/769,646, filed on Feb. 26, 2013.

(51) Int. Cl. H02K 7/06

(52) U.S. Cl. CPC H02K 7/06
USPC 310/20; 310/26

(57) ABSTRACT

A device generates electrical energy from mechanical motion in a downhole environment. The device converts rotary motion into a linear strain in a magnetostrictive material. The device includes a rotor, a magnetostrictive element, and an electrically conductive coil. The rotor rotates within a stator of a drill string. The magnetostrictive element is attached to the rotor by a first ball joint. The magnetostrictive element is configured to experience axial strain in response to rotational movement of the rotor. The magnetostrictive element includes a second ball joint on an end of the magnetostrictive element opposite the first ball joint. The electrically conductive coil is disposed in proximity to the magnetostrictive element. The electrically conductive coil is configured to generate an electrical current in response to a change in flux density of the magnetostrictive element.

### CROSS-REFERENCE TO RELATED APPLICATIONS

This application claims the benefit of U.S. Provisional Application No. 61/769,646, filed on Feb. 26, 2013, which is incorporated by reference herein.

### SUMMARY

Embodiments of a device are described. In one embodiment, the device generates electrical energy from mechanical motion in a downhole environment. The device converts rotary motion into a linear strain in a magnetostrictive material. The device includes a rotor, a connecting rod, a swash plate, a magnetostrictive element, and an electrically conductive coil. The rotor rotates within a stator of a drill string. The swash plate is the interface between the connecting rod and the rotor. The connecting rod is configured to experience axial displacement in response to rotation of the rotor. The magnetostrictive element is attached to the connecting rod. The magnetostrictive element is configured to experience axial strain in response to the axial displacement of the connecting rod. The electrically conductive coil is disposed in proximity to the magnetostrictive element. The coil is configured to generate an electrical current in response to a change in flux density of the magnetostrictive element.

In another embodiment, a device generates electrical energy from mechanical motion in a downhole environment. The device converts rotary motion into a linear strain in a magnetostrictive material. The device includes a rotor, a magnetostrictive element, and an electrically conductive coil. The rotor rotates within a stator of a drill string. The magnetostrictive element is attached to the rotor by a first ball joint and includes a second ball joint on an end of the magnetostrictive element opposite the first ball joint. The magnetostrictive element is configured to experience axial strain in response to rotational movement of the rotor. The electrically conductive coil is disposed in proximity to the magnetostrictive element. The coil is configured to generate an electrical current in response to a change in flux density of the magnetostrictive element.

In another embodiment, a device converts rotary motion into a strain in a magnetostrictive element and generates electrical energy. The device includes a rotor, a rotating shaft, a magnetostrictive element, and an electrically conductive coil. The rotor rotates within a stator of a drill string. The rotating shaft is connected to the rotor at a first end of the rotating shaft. The rotating shaft rotates about an axis of the rotating shaft and moves radially within a drill collar. The second end of the rotating shaft is housed within a radial bearing to restrict radial movement within the drill collar at the second end. The magnetostrictive element is attached to the rotating shaft. The magnetostrictive element rotates about an axis of the magnetostrictive element. The magnetostrictive element is configured to experience a change in flux density due to axial strain in response to movement of the rotating shaft. The electrically conductive coil is disposed in proximity to the magnetostrictive element to generate an electrical current in response to the change in flux density of the magnetostrictive element. Other embodiments of the device are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts one embodiment of a magnetostrictive power take-off assembly.

FIG. 2 depicts one embodiment of a device for converting rotary motion of a rotor into an axial strain in a magnetostrictive element using a swash plate and a connecting rod.

FIG. 3 depicts another embodiment of a device for converting rotary motion of a rotor into an axial strain in a magnetostrictive element including a load piston and a swash plate.

FIG. 4 depicts another embodiment of a device for converting rotary motion of a rotor into an axial strain in a magnetostrictive element including ball joints.

FIG. 5 depicts an embodiment of a device for converting rotary motion into a strain in a magnetostrictive element.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Although many embodiments are described herein, at least some embodiments use mechanical means of transferring the rotation of a rotor in a downhole environment to an axial deflection of a magnetostrictive element, which results in changes in the magnetic properties and, thereby inducing a voltage in a coil proximate the magnetostrictive element. Embodiments described herein are different from conventional devices.

In one embodiment, a mechanism is proposed for converting rotary motion into linear force/motion in a downhole drilling application. A swash plate or similar device may be mounted coaxially to the rotor. As the rotor rotates and precesses the axis of the swash plate will trace out a circle with radius equal to the amount of eccentricity between the rotor and stator. The surface of the swash plate will interface with a connecting rod. The connecting rod will transfer force to the magnetostrictive power take off assembly which includes a magnetostrictive element. The surface of the swash plate can be designed to have one or multiple peaks and valleys for each rotation. Having multiple peaks and valleys will increase the frequency of the loading imposed on the magnetostrictive material. As the rotor rotates the magnetostrictive material power take off assembly will be forced to undergo changes in length and therefore changes in stress. The changes in stress induce a voltage in a coil located near the magnetostrictive element.

In another embodiment, a configuration comprises of the magnetostrictive material power take off mounted to the rotor through a ball joint. The joint could also be a constant velocity joint or other mechanical joint allowing for rotation about multiple planes or axes. Another joint would be used at the opposite end of the magnetostrictive material power take off and would be mounted in a manner to allow for the flow of mud. As the rotor rotates and precesses the magnetostrictive material power take off will be forced to undergo changes in length and therefore changes in stress and thereby induce a voltage in a coil proximate the magnetostrictive material.

In another embodiment, a mechanism for converting rotary motion into linear force/motion in a downhole drilling application includes a swash plate or similar device which may be mounted coaxially to the connecting rod. A load piston is mounted to the rotor. The load piston may be mounted eccentrically to the rotor. As the rotor rotates and precesses the axis of the load piston will trace out a circle with radius equal to the amount of eccentricity between the rotor and stator. The surface of the swash plate will interface with the load piston. The connecting rod will transfer force to the magnetostrictive power take off assembly. The surface of the swash plate can be designed to have one or multiple peaks and valleys for each rotation. Having multiple peaks and valleys will increase the frequency of the loading imposed on the magnetostrictive material.

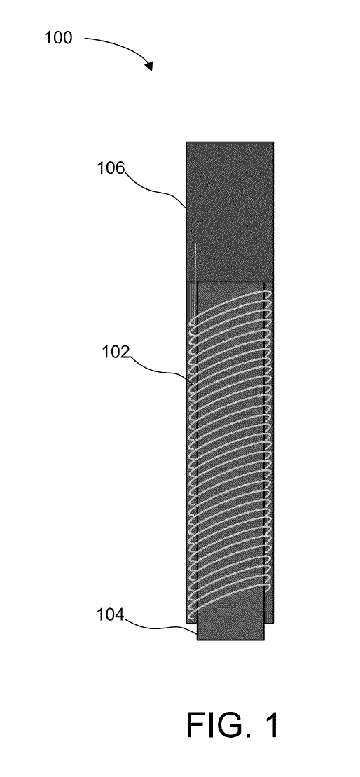

FIG. 1 depicts one embodiment of a magnetostrictive power take off assembly 100. The magnetostrictive power take off assembly includes an electrically conductive coil 102 disposed in proximity to a magnetostrictive element 104 and is connected to electronics 106 to harvest.

In some embodiments, the magnetostrictive power take off assembly 100 may include a plurality of magnetostrictive elements 104. In some embodiments, the magnetostrictive power take off assembly 100 may include a plurality of electrically conductive coils 102. The magnetostrictive elements 104 may be attached in series, in parallel, in a combination of the two. The electrically conductive coil 102 may be wrapped around the magnetostrictive element 104 or may be placed near the magnetostrictive element 104. The electrically conductive coil 102 may be placed in as close proximity as necessary to experience a change in the flux density of the magnetostrictive element 104. The magnetostrictive power take off assembly 100 may include any equipment necessary to harvest, store, and utilize energy generated from the magnetostrictive power take off assembly 100.

In some embodiments, the magnetostrictive element 104 may be pre-stressed by way of a fixture coupled to the magnetostrictive element 104. The fixture may be a compression fixture for maintaining a compressive force on the magnetostrictive element 104 throughout the range of relative motion of the magnetostrictive element 104. The magnetostrictive element 104 may also be pre-stressed as a result of processing the magnetostrictive element 104. Examples may include but are not limited to quenching after processing or after annealing, or incorporation of second phases or coating that may result in residual stresses in the material.

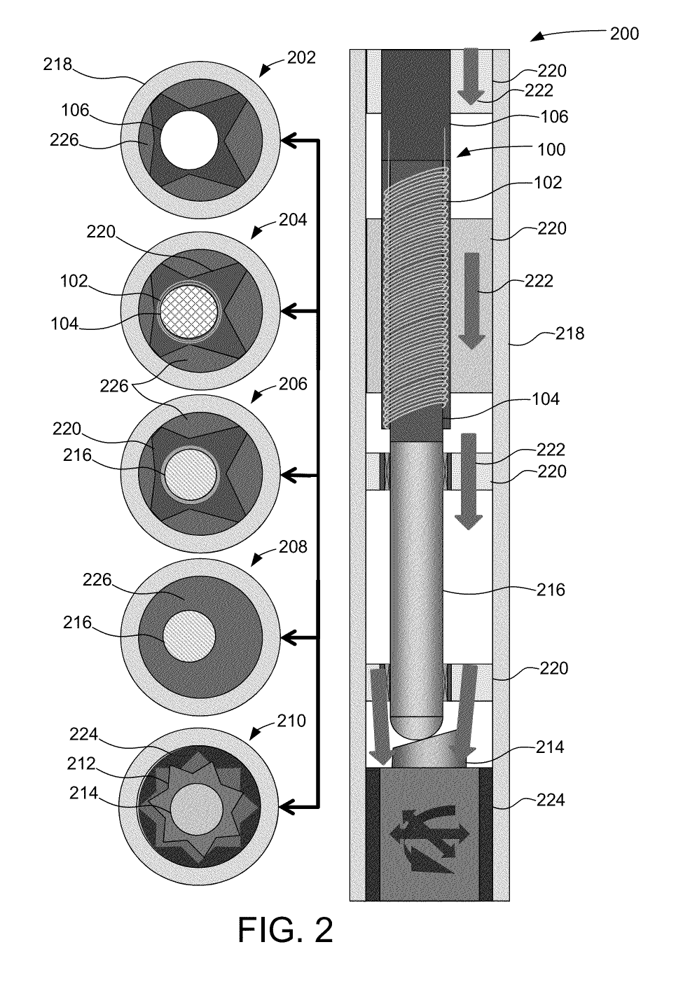

FIG. 2 depicts one embodiment of a device 200 for converting rotary motion of a rotor 212 into an axial strain in a magnetostrictive element 104 using a swash plate 214 and a connecting rod 216. Also, cutaways 202-210 are illustrated showing the cross section within the drill collar or housing 218 at various points along the drill collar 218.

The device 200 for converting rotary motion into an axial strain in a magnetostrictive element 104 may be located within drill collar 218. Within the drill collar is a magnetostrictive power take off assembly 100 which includes a magnetostrictive element 104, and electrically conductive coil 102 and electronics 106. The magnetostrictive power take off assembly 100 may include any equipment necessary to harvest, store, and utilize energy generated from the magnetostrictive power take off assembly 100. In the illustrated embodiment, the magnetostrictive power take off assembly 100 is non-rotating. The magnetostrictive element 104 is connected to a connecting rod 216. The connecting rod 216 reciprocates as it interacts with the swash plate 214. The connecting rod 216 and the magnetostrictive power take off assembly 100 are housed within bearings 220 to restrict movement radially. The radial bearings 220 allow the flow of mud 226 (illustrated by the arrows 222) down the drill collar to drive the rotor 212. As the mud flows down into the stator 224, the rotor 212 rotates within the stator 224. The rotor 212 will rotate about an axis and move radially within the stator 224. In the illustrated embodiment, the swash plate 214 is connected to the rotor 212. The surface of the swash plate 214 is contoured. The swash plate 214 rotates and moves radially and follows the precession of the rotor 212, the surface of the swash plate 214 will contact the connecting rod 216 and cause the connecting rod 216 to reciprocate. As the connecting rod 216 reciprocates, the axial displacement of the connecting rod 216 will produce an axial strain on the magnetostrictive element 104 which will produce a change in flux density of the magnetostrictive element 104 which will generate an electrical current within the coil 102. In the illustrated embodiment, the connecting rod 216 and magnetostrictive power take off assembly 100 are placed eccentrically within the drill collar 218.

The contour of the surface of the swash plate 214 can be designed to produce the optimum level of axial displacement of the connecting rod 216 to produce the optimum change in strain in the magnetostrictive element 104. In some embodiments, the swash plate 214 is configured to have more than one peak and more than one valley in a single rotation of the swash plate 214. Those skilled in the art may envision other ways of converting rotary motion into an axial strain in addition to the use of the swash plate. Additionally, the order of the features and connections as described in conjunction with FIG. 2 may be changed in various embodiments.

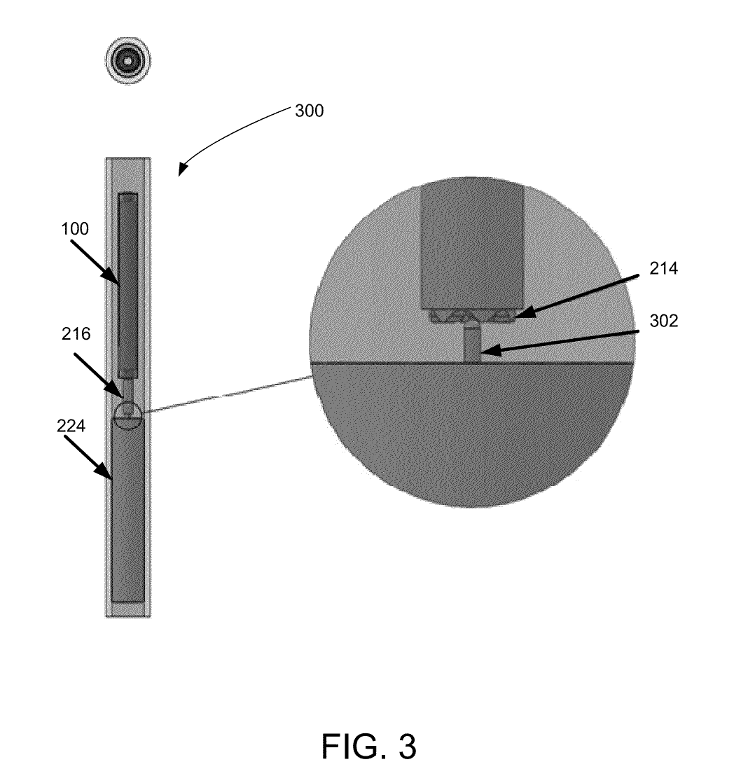

FIG. 3 depicts another embodiment of a device 300 for converting rotary motion of a rotor into an axial strain in a magnetostrictive element including a rotor load piston 302 and a swash plate 214. The device 300 for converting rotary motion of a rotor into an axial strain in a magnetostrictive element includes a magnetostrictive power take off assembly 100, a swash plate transfer mechanism including a connecting rod 216 in communication with a rotor and stator 224. The magnetostrictive power take off assembly 100 includes a magnetostrictive element 104, and electrically conductive coil 102 and any equipment necessary to harvest, store, and utilize energy generated from the magnetostrictive power take off assembly 100.

A rotor load piston 302 is connected to the rotor and may rotate and move radially within the drill collar following the precession of the rotor within the stator 224. The rotor load piston 204 interfaces with a swash plate 214. The swash plate 214 is connected to the connecting rod 216 and the connecting rod 216 is connected to the magnetostrictive power take off assembly 100. As the rotor load piston 302 moves and rotates with the rotor, the interface with the contours of the swash plate 214 convert the rotary motion of the rotor to axial displacement of the connecting rod 216. The axial displacement of the connecting rod 216 produces and axial strain in the magnetostrictive element which generates a change in flux density and generates an electrical current.

In another embodiment, the positions of the swash plate 214 and the load piston 302 are reversed. So the swash plate 214 is coupled to the top of the rotor within the stator 224 and may rotate and move radially within the drill collar following the precession of the rotor within the stator 224. The load piston 302 is coupled to the connecting rod 216. In this embodiment, the swash plate 214 rotates, while the load piston 302 remains in a relatively fixed position.

In further embodiments, the power take off assembly 100, the connecting rod 216, and the load piston 302 are offset to one side or the other, so that the load piston is a further distance from the longitudinal axis of the rotor and stator 224. In other embodiments, the load piston 302 and/or the connecting rod 216 also may be offset from the longitudinal axis of the power take off assembly 100. In other embodiments, other types of connectors may be used, in place of the connecting rod 216, to connect the swash plate 214 or the load pin 302 to the power take off assembly 100 and/or the rotor within the stator 224.

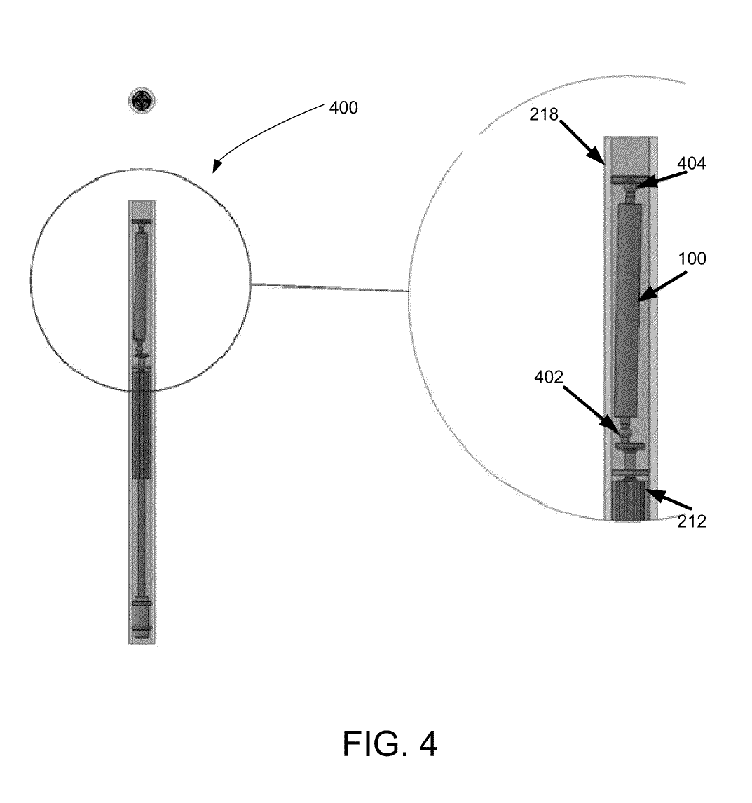

FIG. 4 depicts another embodiment of a device 400 for converting rotary motion of a rotor 212 into an axial strain in a magnetostrictive element 104 including ball joints 402-404. The illustrated embodiment includes a rotor 212 configured to rotate within a stator 224. The magnetostrictive power take off assembly 100 is attached to the rotor 212 by a first ball joint 402 and includes a second ball joint 404 on an end of the magnetostrictive power take off assembly 100 opposite the first ball joint 402. The magnetostrictive power take off assembly 100 includes a magnetostrictive element 104, and electrically conductive coil 102 and any equipment necessary to harvest, store, and utilize energy generated from the magnetostrictive power take off assembly 100. The magnetostrictive element 104 is configured to experience axial strain in response to rotational movement of the rotor 212. The electrically conductive coil 102 is disposed in proximity to the magnetostrictive element 104. The electrically conductive coil 102 is configured to generate an electrical current in response to a change in flux density of the magnetostrictive element 104.

In some embodiments, the first ball joint 402 rotates with the rotor 212. The magnetostrictive element 104 is configured to experience axial strain in response to the relative movement between the two ball joints 402-404. In some embodiments, the magnetostrictive power take off assembly 100 may include a plurality of magnetostrictive elements 104. In some embodiments, the magnetostrictive power take off assembly 100 may include a plurality of electrically conductive coils 102. The magnetostrictive elements 104 may be attached in series, in parallel, in a combination of the two. The electrically conductive coil 102 may be wrapped around the magnetostrictive element 104 or may be placed near the magnetostrictive element 104. The electrically conductive coil 102 may be placed in as close proximity as necessary to experience a change in the flux density of the magnetostrictive element 104.

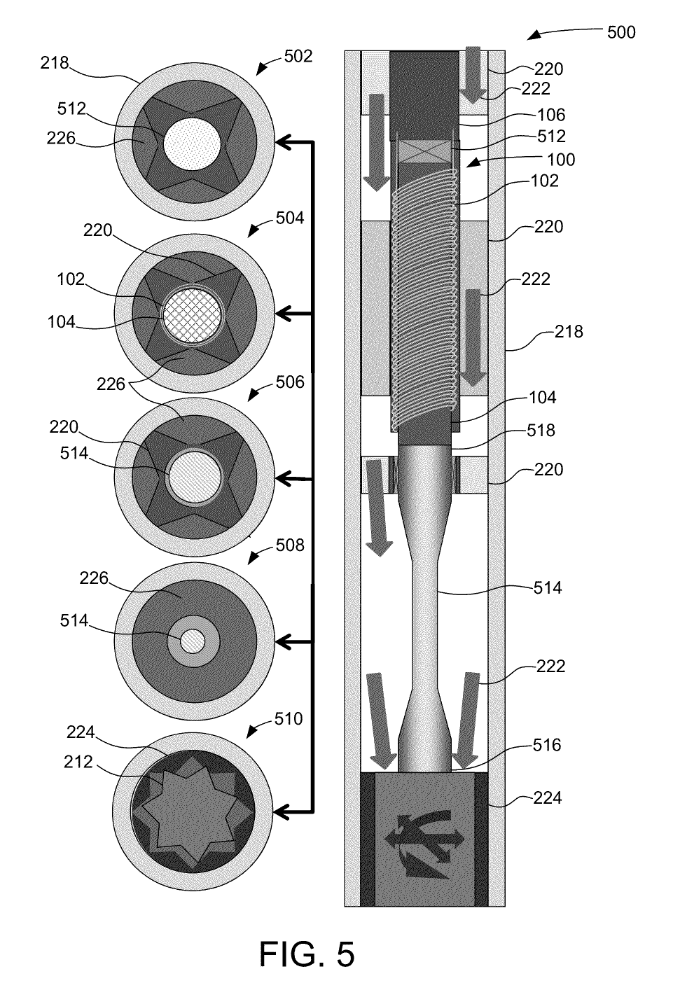

FIG. 5 depicts an embodiment of a device 500 for converting rotary motion into a strain in a magnetostrictive element 104. Cutaways 502-510 are also illustrated showing the cross section within the drill collar or housing 218 at various points along the drill collar 218.

The device 500 for converting rotary motion into a strain in a magnetostrictive element 104 may be located within drill collar 218. Within the drill collar is a magnetostrictive power take off assembly 100 which includes a magnetostrictive element 104, and electrically conductive coil 102 and electronics 106. The magnetostrictive power take off assembly 100 may include any equipment necessary to harvest, store, and utilize energy generated from the magnetostrictive power take off assembly 100. The illustrated embodiment also includes a thrust bearing 512. In the illustrated embodiment, the magnetostrictive element 104 is rotating. The magnetostrictive element 104 is connected to a bending shaft 514. The bending shaft 514 rotates with the rotor 212. The bending shaft 514 and the magnetostrictive power take off assembly 100 are housed within bearings 220 to restrict movement radially. The radial bearings 220 allow the flow (illustrated by the arrows 222) of mud 226 down the drill collar 218 to drive the rotor 212. As the mud flows down into the stator 224, the rotor 212 rotates within the stator 224. The rotor 212 will rotate about an axis and move radially within the stator 224. In the illustrated embodiment, the bending shaft 514 is connected to the rotor 212 at a first end 516 of the bending shaft 514 and rotates with the rotor 212. The bending shaft 514 at the first end moves radially within the drill collar 218 following the precession of the rotor 212. At a second end 518 of the bending shaft 514, the bending shaft 514 is housed within a radial bearing 220. The radial bearing 220 restricts the radial movement of the bending shaft 514 at the second end 518 within the drill collar 218. The bending shaft 514 is connected to the magnetostrictive power take off assembly 100 at the second end 518. As the bending shaft 514 rotates and moves radially at the first end 516, the movement will produce an axial strain on the magnetostrictive element 104 which will produce a change in flux density of the magnetostrictive element 104 which will generate an electrical current within the coil 102. In the illustrated embodiment, the second end 518 of the bending shaft 514 and the magnetostrictive power take off assembly 100 are placed centrally within the drill collar 218 but may be placed eccentrically within the drill collar 218.

In one embodiment, a device 500 uses the radial motion of the eccentric center-point of the rotor 212 of a mud motor to displace the tip of a magnetostrictive power take off assembly 100 that is hinged at both ends. One of these hinged ends is connected to a bending shaft 514 that is connected to the rotor 212, and the other is connected to a rigid point above. For example, the other end may be connected to a shaft that is mechanically coupled to a drill bit and may be housed within radial bearings 220 to prevent radial movement. This allows the device to operate in an axial-loading configuration rather than a flexing or bending configuration. Assuming the force is sufficiently high, the displacement will cause the bending shaft 514 to displace axially at the second end 518 and cause an axial loading of the magnetostrictive element 104.

Although various embodiments have been described, those skilled can recognize methods of generating electrical energy by use of the devices and features described herein. Additionally, those skilled in the art can recognize equivalents and substitutions that substantially utilize the teachings and embodiments described herein.

Other embodiments may incorporate one or more other aspects from related descriptions, including the subject matter described and shown in U.S. application Ser. No. 12/603,138, filed on Oct. 21, 2009, and entitled “Method and Device for Harvesting Energy from Ocean Waves,” U.S. application Ser. No. 13/016,828, filed on Jan. 28, 2011, and entitled “Wave Energy Harvester with Improved Performance,” U.S. application Ser. No. 13/016,895, filed on Jan. 28, 2011, and entitled “Apparatus for Harvesting Electrical Power from Mechanical Energy,” U.S. application Ser. No. 13/361,806 filed on Jan. 30, 2012, and entitled “Energy Harvesting Methods and Devices, and Applications Thereof,” U.S. Provisional Application No. 61/664,444, filed on Jun. 26, 2012, and entitled “Magnetostrictive Wave Energy Harvester with Heave Plate,” U.S. Provisional Application No. 61/668,280, filed on Jul. 5, 2012, and entitled “Power Generation MWD/LWD Tools and Telemetry,” U.S. Provisional Application No. 61/674,982, filed on Jul. 24, 2012, and entitled “Method and Device for Downhole Power Generation,” and U.S. Provisional Application No. 61/738,757, filed on Dec. 18, 2012, and entitled “Downhole Energy Harvesting Method and Device,” U.S. Provisional Application No. 61/767,689, filed on Feb. 21, 2013, and entitled “Heave Plate Mooring for Wave Energy Conversion (WEC) Via Tension Changes” each of which is incorporated herein in its entirety.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device for converting rotary motion into a linear strain and generating electrical energy, the device comprising:
a rotor to rotate within a stator of a drill string;
a magnetostrictive element attached to the rotor by a first ball joint, wherein the magnetostrictive element is configured to experience axial strain in response to rotational movement of the rotor, wherein the magnetostrictive element comprises a second ball joint on an end of the magnetostrictive element opposite the first ball joint; and
an electrically conductive coil disposed in proximity to the magnetostrictive element, wherein the coil is configured to generate an electrical current in response to a change in flux density of the magnetostrictive element.

2. The device of claim 1, wherein the first ball joint rotates with the rotor, wherein magnetostrictive element is configured to experience axial strain in response to the relative movement between the two ball joints.

3. The device of claim 1, further comprising:
a plurality of magnetostrictive elements; and
a plurality of electrically conductive coils.

4. The device of claim 3, wherein the plurality of magnetostrictive elements are attached in series.

5. The device of claim 3, wherein the plurality of magnetostrictive elements are attached in parallel.

6. A device for converting rotary motion into a linear strain and generating electrical energy, the device comprising:
a rotor to rotate within a stator of a drill string;
a connecting rod interfacing with the rotor by a swash plate, wherein the connecting rod is configured to experience axial displacement in response to rotation of the rotor; and
a magnetostrictive element attached to the connecting rod, wherein the magnetostrictive element is configured to experience axial strain in response to the axial displacement of the connecting rod; and
an electrically conductive coil disposed in proximity to the magnetostrictive element, wherein the coil is configured to generate an electrical current in response to a change in flux density of the magnetostrictive element.

7. The device of claim 6, wherein the swash plate is mounted to the rotor, wherein the swash plate is configured to rotate with the rotor.

8. The device of claim 7, wherein the connecting rod is interfacing with a surface of the swash plate, wherein the connecting rod is configured to experience axial displacement in response to rotation of the swash plate.

9. The device of claim 8, wherein the surface of the swash plate is contoured, wherein the swash plate is configured to have more than one peak and more than one valley in a single rotation of the swash plate.

10. The device of claim 6, further comprising:
a plurality of magnetostrictive elements; and
a plurality of electrically conductive coils.

11. The device of claim 10, wherein the plurality of magnetostrictive elements are attached in series.

12. The device of claim 10, wherein the plurality of magnetostrictive elements are attached in parallel.

13. The device of claim 6, further comprising a compression fixture coupled to the magnetostrictive element to maintain the magnetostrictive element in compression throughout a range of relative motion of the connecting rod.

14. The device of claim 6, wherein the swash plate is mounted to the connecting rod.

15. The device of claim 14, further comprising a rotor load piston mounted to the rotor.

16. The device of claim 15, wherein the rotor load piston is interfacing with a surface of the swash plate.

17. The device of claim 16, wherein the surface of the swash plate is contoured, wherein the swash plate is configured to have more than one peak and more than one valley in a single rotation of the swash plate.

18. A device for converting rotary motion into a strain in a magnetostrictive element and generating electrical energy, the device comprising:
a rotor to rotate within a stator of a drill string;
a rotating shaft connected to the rotor at a first end of the rotating shaft, wherein the rotating shaft rotates about an axis of the rotating shaft and moves radially within a drill collar, wherein a second end of the rotating shaft is housed within a radial bearing to restrict radial movement within the drill collar at the second end; and
a magnetostrictive element attached to the rotating shaft, wherein the magnetostrictive element rotates about an axis of the magnetostrictive element, wherein the magnetostrictive element is configured to experience a change in flux density due to axial strain in response to movement of the rotating shaft; and
an electrically conductive coil disposed in proximity to the magnetostrictive element to generate an electrical current in response to the change in flux density of the magnetostrictive element.

19. The device of claim 18, further comprising:
a plurality of magnetostrictive elements; and
a plurality of electrically conductive coils.

20. The device of claim 19, wherein the plurality of magnetostrictive elements are attached in series.
